(19) United States
(12) Patent Application Publication
(10) Pub. No.: US 2007/0088918 A1
(43) Pub. Date: Apr. 19, 2007

(54) Tracking dependencies among memory requests

(75) Inventor: Balakrishna Venkatrao, Cambridge, MA (US)

Correspondence Address: DARBY & DARBY, P.C., P.O. BOX 5257, NEW YORK, NY, 10150-5257, US

(73) Assignee: Sun Microsystems, Inc.

(21) Appl. No.: 11/249,254

(22) Filed: Oct. 13, 2005

(51) Int. Cl. G06F 13/00

(52) U.S. Cl. 711/154

(57) ABSTRACT

Encoding positional information to track dependencies among memory requests resident in a memory request buffer increases efficiency of submitting those requests to memory. With the encoded positional information representing dependencies, a mechanism that selects memory requests for submission to memory can select memory requests without being hindered by determining dependencies repeatedly. In addition, the encoded positional information can be update incident with return of service indication from memory for a memory request.

### BACKGROUND

1. Field of the Invention

The invention relates to computers, and more specifically, relates to handling memory requests.

2. Description of the Related Art

Memory requests, such as loads and stores, typically are queued in a memory controller prior to submission to memory. A queued memory request is submitted once the memory controller determines that the memory request is not dependent upon another memory request. Each time the memory returns an indication that a memory request has been serviced (e.g., data for a load is returned from the memory), the memory controller dequeues the serviced memory request, and re-examines the targets of the queued memory requests to locate another dependency free memory request. Unfortunately, the re-examination of targets introduces significant delay.

### SUMMARY

It has been discovered that tracking dependencies among memory requests with a higher level of granularity increases the efficiency of selecting memory requests for submission to a memory. The higher level of granularity indicates with specificity the dependencies among the memory requests instead of merely indicating a dependency exists with at least one other memory request. The higher level of granularity of dependency allows more efficient clearing of dependencies and more efficient reaction to dependencies being cleared responsive to a memory being serviced. The dependency information for a memory request can be represented with a dependency vector in a dependency matrix. For example, a column of the dependency matrix may indicate memory requests that dependent upon the memory request represented by the column and a row of the dependency matrix may indicate dependencies of a memory request represented by the row. Encoding the dependencies between memory requests in a memory buffer instead of a vague indication that a dependency exists for a memory request allows logic that handles memory requests, such as a memory controller, to more efficiently react to indications that a memory request has been serviced, in both clearing dependencies upon a serviced memory request and selecting a dependency free memory request for submission to a memory.

These and other aspects of the described invention will be better described with reference to the Detailed Description and accompanying Figures.

### BRIEF DESCRIPTION OF THE DRAWINGS

The present invention may be better understood, and its numerous objects, features, and advantages made apparent to those skilled in the art by referencing the accompanying drawings.

FIG. 1 depicts an example of a system with a memory controller and memory.

FIG. 2 depicts an example memory request buffer.

FIG. 3 depicts example circuitry for a dependency matrix.

FIGS. 4A - 4B depict example tracking of dependencies among memory requests. FIG. 4A depicts an example memory request buffer and dependency matrix with an incoming memory request. FIG. 4B depicts an example of a memory request being submitted to memory.

FIG. 5 depicts an exemplary computer system according to realizations of the invention.

The use of the same reference symbols in different drawings indicates similar or identical items.

### DETAILED DESCRIPTION

The description that follows includes exemplary systems, methods, techniques, and instruction sequences that embody techniques of the present invention. However, it is understood that the described invention may be practiced without these specific details. For instance, the size of the depicted memory request buffer and dependency matrix are only examples. It should be understood that both structures can be of greater or smaller size. In other instances, well-known protocols, structures and techniques have not been shown in detail in order not to obscure the invention.

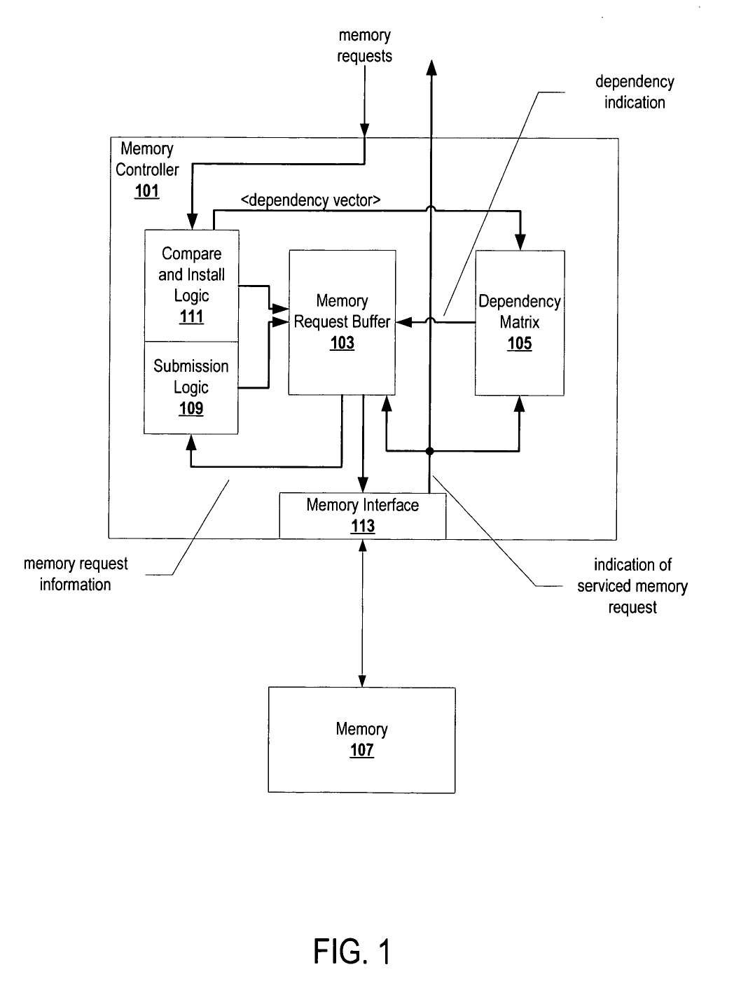

FIG. 1 depicts an example of a system with a memory controller and memory. In FIG. 1, a memory controller 101 is coupled with a memory 107. Although a number of variations exist (e.g., the memory controller may be coupled with additional memories, the system may include multiple memory controllers, etc.), a single memory controller and a single memory are depicted to avoid obfuscating the described invention. The memory controller 101 receives memory requests, for example from an instruction scheduler. The memory controller 101 includes compare and install logic 111, submission logic 109, a memory request buffer 103, a memory interface 113, and a dependency matrix 105. Those of ordinary skill in the art will appreciate that the memory controller 101 includes additional circuitry, such as snoop circuitry, bus interface circuitry, etc., which are not depicted.

Received memory requests are installed into the memory request buffer 103 by the compare and install logic 111. The compare and install logic 111 also compares a received memory request against memory requests resident in the memory request buffer 103. The compare and install logic 111 compares a target and age of a received memory request against targets and ages of the pending memory requests in the memory request buffer 103 to determine if any dependencies exist. Based upon this comparison, the compare and install logic 111 constructs a dependency vector that indicates dependencies. For example, the memory controller 101 receives a read request for a target <A>. The compare and install logic 111 locates an available entry in the memory request buffer 103, such as an empty entry or an entry marked as invalid (e.g., a memory request that has been serviced). The compare and install logic 111 installs the memory request in the available entry (e.g., entry 5) and compares the age and target of the read request against age and target of memory requests already resident in the memory request buffer. If the read request is younger than a resident memory request, both for the same targets, then a dependency exists. The dependency between a first and a second memory requests is established regardless request types, since a dependent memory request (the second memory request) waits for the sequence of action or operations, such as transferring ownership, of the first memory request to complete for cache coherency purposes. Each bit position of the dependency vector corresponds to an entry in the memory request buffer (e.g., the least significant bit (LSB) (or the most significant bit (MSB)) represents entry 1 in the memory request buffer, the bit next to the LSB represents the second entry, etc.).

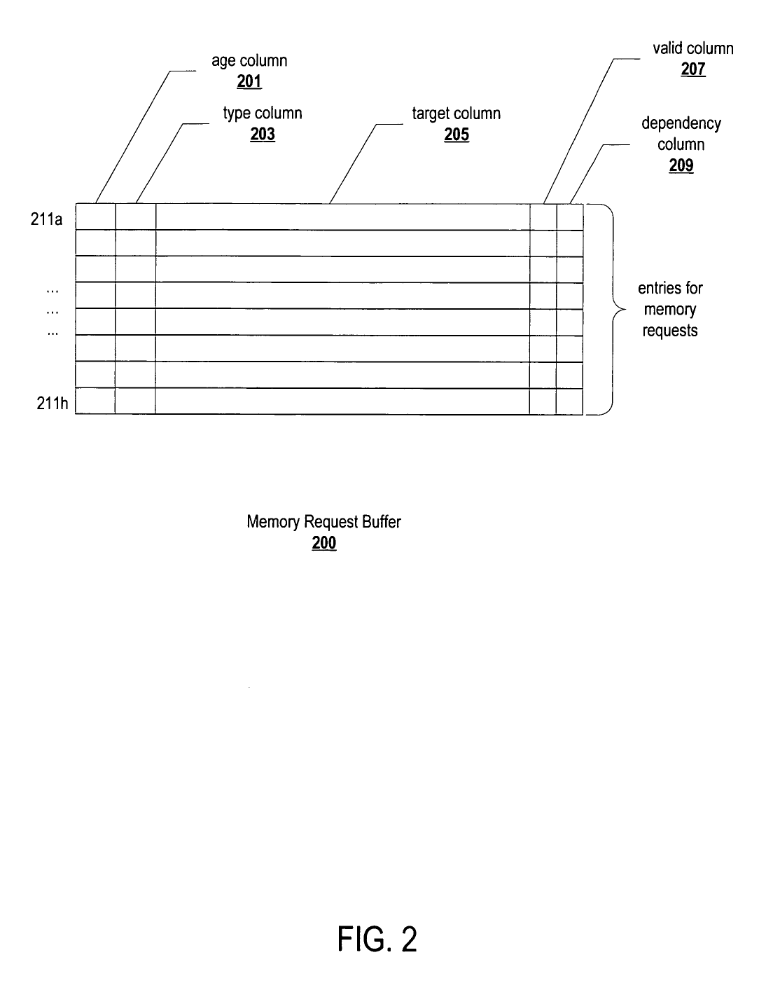

FIG. 2 depicts an example memory request buffer. A memory request buffer 200 includes eight entries for memory requests. The memory request buffer 200 comprises five columns: an age column 201, a type column 203, a target column 205, valid column 207, and a dependency column 209. The age column 201 for each entry indicates an age of a memory request. The age indication is typically assigned prior to the memory request arriving in the memory request buffer 200 (e.g., an age is assigned by an instruction scheduler). The type column 203 indicates whether a memory request is a read type memory request or a write type memory request. However, embodiments may not implement a type column since determining dependency does not require such information. The target column 205 indicates a target of a memory request, such as an address to be written or read. The valid column 207 indicates whether a valid memory request resides at a particular entry, thus indicating that the memory request is available to be submitted to memory. If a memory request has an invalid indication, then it can be cleared and/or overwritten. The dependency column 209 indicates whether a dependency exists for a memory request at a particular entry. If a valid entry of the memory request buffer 200 has an indication of being free of dependencies, then the memory request at the entry can be submitted to memory causing data to be written to a target or read from a target.

Referring again to FIG. 1, assuming there are 8 entries in the memory request buffer 103, then if the installed read request is dependent upon the memory request at the first entry and the fourth entry of the memory request buffer 103, then the compare and install logic 111 should construct the following dependency vector ‘10010000’. A constructed dependency vector is written into the dependency matrix 105. Although implementations may vary, the compare and install logic 111 can initially set a dependency bit in the memory request buffer for an installed memory request. The dependency bit can then be maintained in accordance with information maintained in the dependency matrix 105. If information in the dependency matrix 105 is updated, then the dependency matrix 105 or logic coupled with the dependency matrix 105 sends a dependency indication for each entry in the memory request buffer 103 that is affected.

The submission logic 109 selects those memory requests pending in the memory request buffer 103 that are free of dependencies. The selected memory requests are submitted to the memory 107 for servicing via the memory interface 113. The submission logic 109 selects memory requests based on memory request information in the memory request buffer 103. The submission logic 109 searches for entries with a valid memory request free of dependencies.

The memory 107 returns an indication of serviced memory requests (e.g., data for a read request) to the memory interface 113. The memory interface 113 forwards a service indication for a memory request back to a corresponding processing unit (e.g., a core or a processor that initiated the memory request). The memory interface 113 also supplies the service indication to the dependency matrix 105 and the memory request buffer 103. The memory request buffer 103 marks an entry for a memory request that has been serviced as invalid, allowing a new memory request to be installed. The dependency matrix 105 updates the dependency information for a serviced memory request to clear dependencies upon the serviced memory request. Those of ordinary skill in the art should appreciate that the memory controller 101 can be implemented to handle a service indication differently. For example, the service indication may be supplied to the dependency matrix 105 instead of both the dependency matrix 105 and the memory request buffer 103. The dependency matrix 105 would then update the memory request buffer 103 to invalidate the corresponding entry as well as updating the dependency information maintained in the dependency matrix 105. In another example, a separate logic receives the service indication and updates appropriate information in both the memory request buffer 103 and the dependency matrix 105. In another example, the memory interface 113 includes logic to update the memory request buffer 103 and the dependency matrix 113.

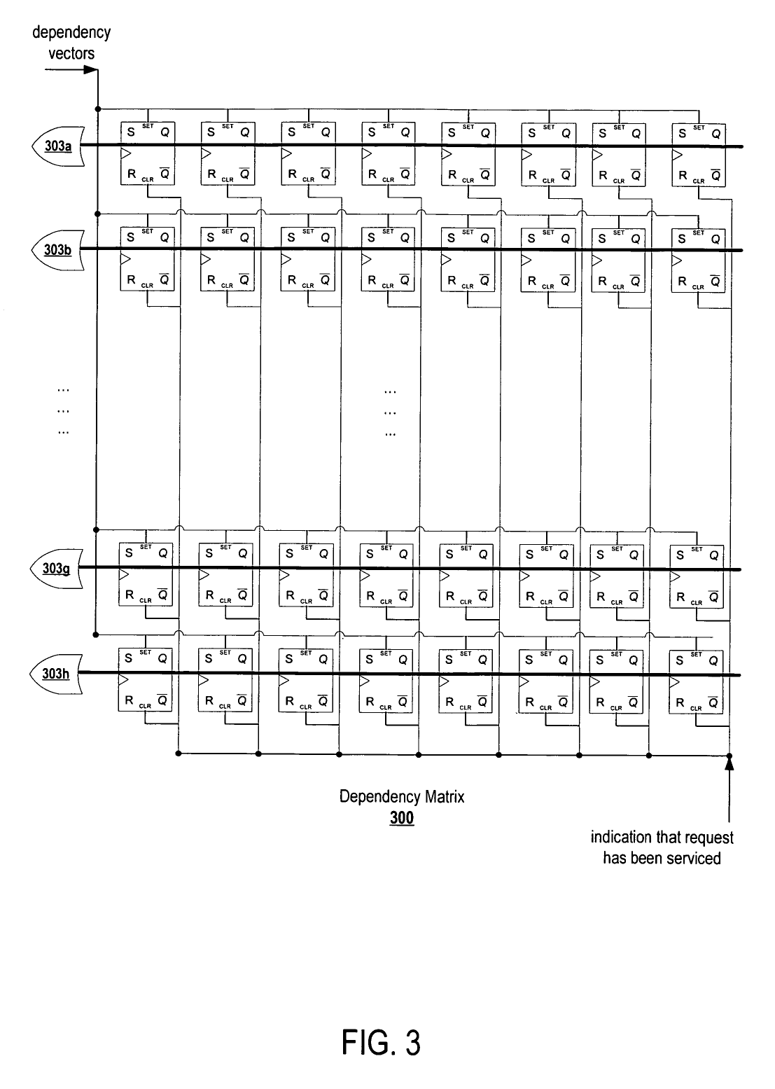

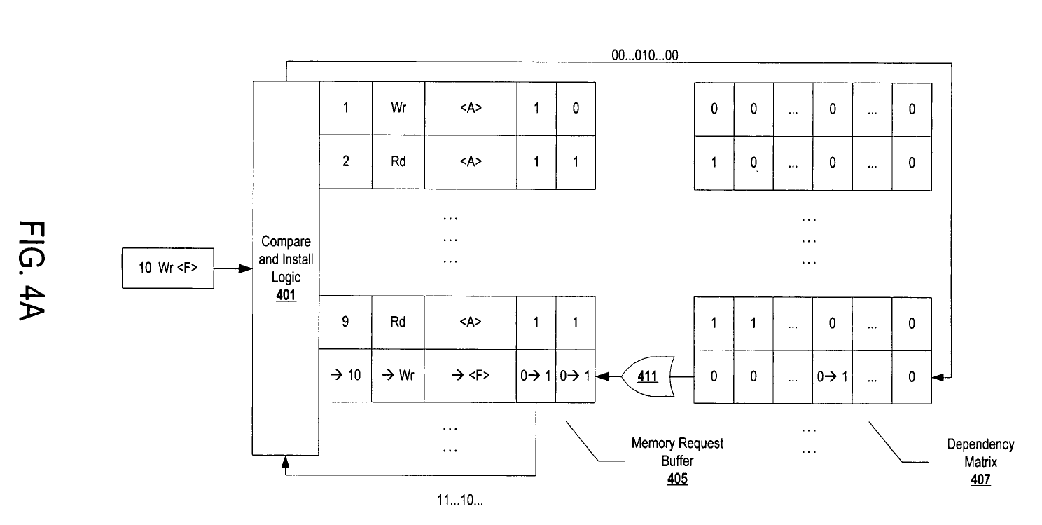

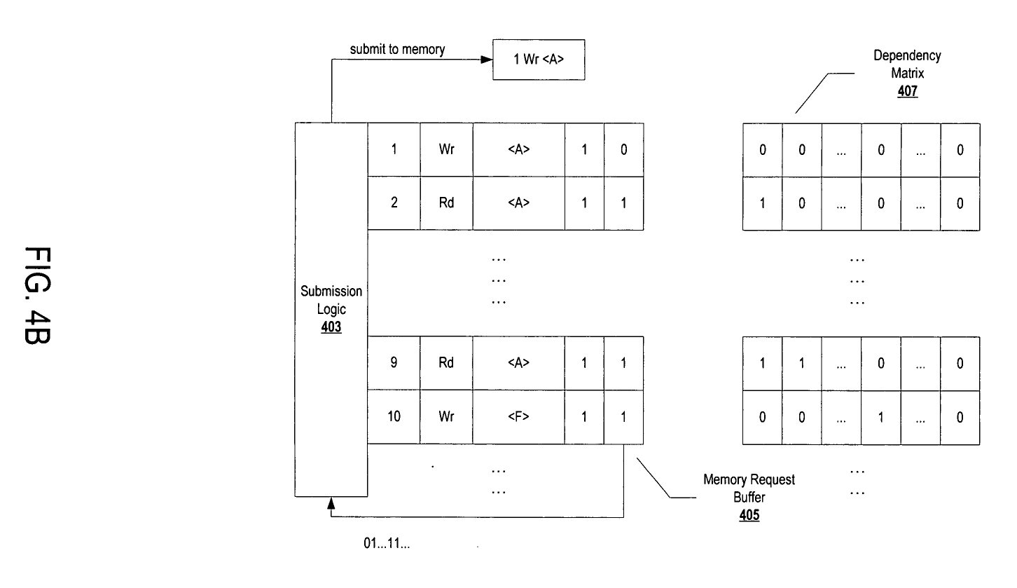

FIG. 3 depicts example circuitry for a dependency matrix. A dependency matrix 300 includes an 8×8 grid of flip-flops. In this example, each row of flip-flops hosts a dependency vector for a corresponding entry in a memory request buffer. Dependency vectors are written into rows of the dependency matrix 300. Each column of the dependency matrix 300 indicates dependencies upon a memory request at a represented entry of the memory request buffer. For example, a memory request resident at a second entry of a memory request buffer has a dependency vector written into the second row of flip-flops of the dependency matrix 300. The second column of the dependency matrix indicates those memory requests that cannot be submitted at least because they are dependent upon the memory request at the second entry of the memory request buffer. When a memory request has been serviced, the corresponding column for the serviced memory request is cleared, thus clearing those memory requests that were dependent upon the serviced memory request. After a memory request has been serviced, and its corresponding column cleared, the dependency information for each row is driven to a respective one of OR gates 303a - 303h. The output of each of the OR gates 303a - 303h is written into a dependency column of a respective entry in the memory request buffer that is coupled with the dependency matrix 300.

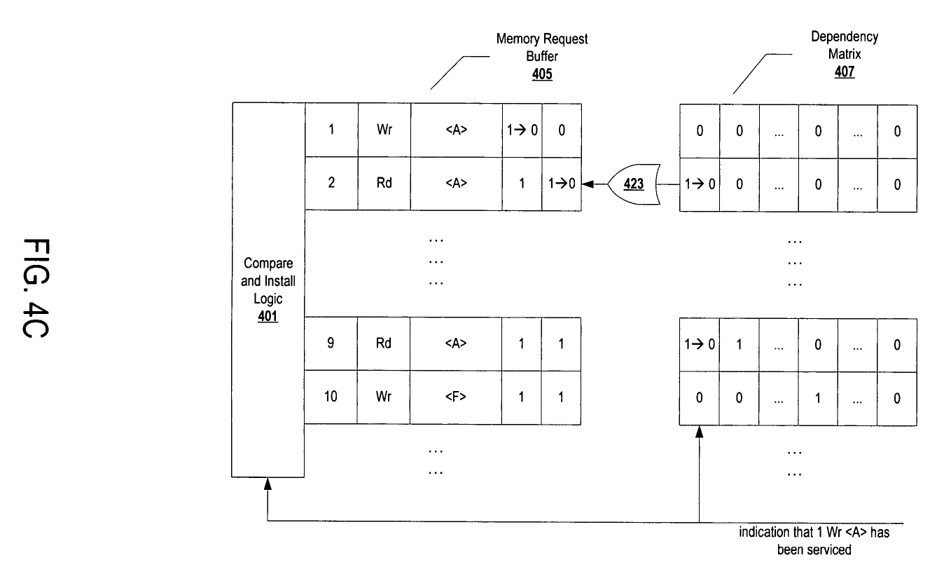

FIGS. 4A - 4B depict example tracking of dependencies among memory requests. FIG. 4A depicts an example memory request buffer and dependency matrix with an incoming memory request. A memory request ‘10 Wr <F>’ is received by a compare and install logic 401. Although various techniques can be implemented for locating an available entry, this example implementation depicts a vector of valid indications being sent from the memory request buffer 405 to the compare and install logic 401. The compare and install logic 401 examines the vector to determine which entries are available. After locating an available entry in the memory request buffer 405, the compare and install logic 401 installs the write request into the memory request buffer 405.

The compare and install logic 401 compares the received write instruction against all older instructions resident in a memory request buffer 405. The compare and install logic 401 determines if there is a resident memory request that is older than 10, which is the age of the incoming write request, with a same target of <F>. From the comparison, the compare and install logic 401 determines that a dependency exists between the incoming write instruction and an older resident instruction that targets <F>. Based upon the comparison, the compare and install logic 401 also constructs a dependency vector for the write request and writes the dependency vector, which indicates the entry hosting the resident memory request that the write request is dependent upon. The dependency vector is written into an entry in a dependency vector that corresponds to the entry of the memory request buffer 407 where the write request has been installed. After the dependency vector is written, the bits of the dependency vector are OR'd together with an OR gate 411 and written into the dependency indication column of the memory request buffer 401 for the installed write request. Of course, the initial setting of the dependency bit for a memory request installed into the memory request buffer 401 may be performed differently. For example, the dependency bit may initially be set incident to construction of the dependency vector, incident to the comparison performed by the compare and install logic 401, etc.

FIG. 4B depicts an example of a memory request being submitted to memory. In FIG. 4B, the memory request buffer 405 sends dependency information for resident memory requests to submission logic 401. The dependency information indicates the existence of a dependency for a memory request. The submission logic 403 selects at least one memory request that is free of dependencies according to the dependency information from the memory request buffer 405. In FIG. 4B, the submission logic selects memory request ‘1 Wr <A>’ and submits the memory request to memory for servicing. An entry in the dependency matrix 405 that represents a dependency vector for the submitted write requests depicts zero dependencies.

FIG. 4C depicts an example of dependencies being cleared. An indication is received by the dependency matrix 407 and the compare and install logic 401. The indication indicates that the memory request ‘1 Wr <A>’ has been serviced (i.e., the data of the memory request has been written to target <A>). Responsive to the service indication, the dependency matrix 407 sets all non-zero values to zero, thus clearing all dependencies upon the serviced write request. In FIG. 4C, the dependency indications in the dependency matrix 407 are cleared for the memory requests ‘2 Rd<A>’ and ‘9 Rd<A>’ . Responsive to the clearing, the rows of the dependency matrix 407 are OR'd together with an OR gate 423 to reset the dependency indication in the memory request buffer 405 if appropriate. The read request ‘9 Rd <A>’ has some dependencies that remain. However, the read request ‘2 Rd <A>’ is no longer dependent upon any resident memory requests. Therefore, the dependency indication in the memory request buffer 405 for the read request ‘2 Rd <A>’ is reset to indicate that the read request is free of dependencies.

Embodiments may be provided as a computer program product, or software, that may be encoded on a machine-readable medium having stored thereon instructions, which may be used to program a computer system (or other electronic devices) to perform some or all of the functionality described above. A machine readable medium includes any mechanism for storing or transmitting information in a form (e.g., firmware) readable by a machine (e.g., a computer). A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, optical, acoustical or other form of propagated signal (e.g., carrier waves, infrared signals, digital signals, etc.); or other types of medium suitable for storing electronic instructions.

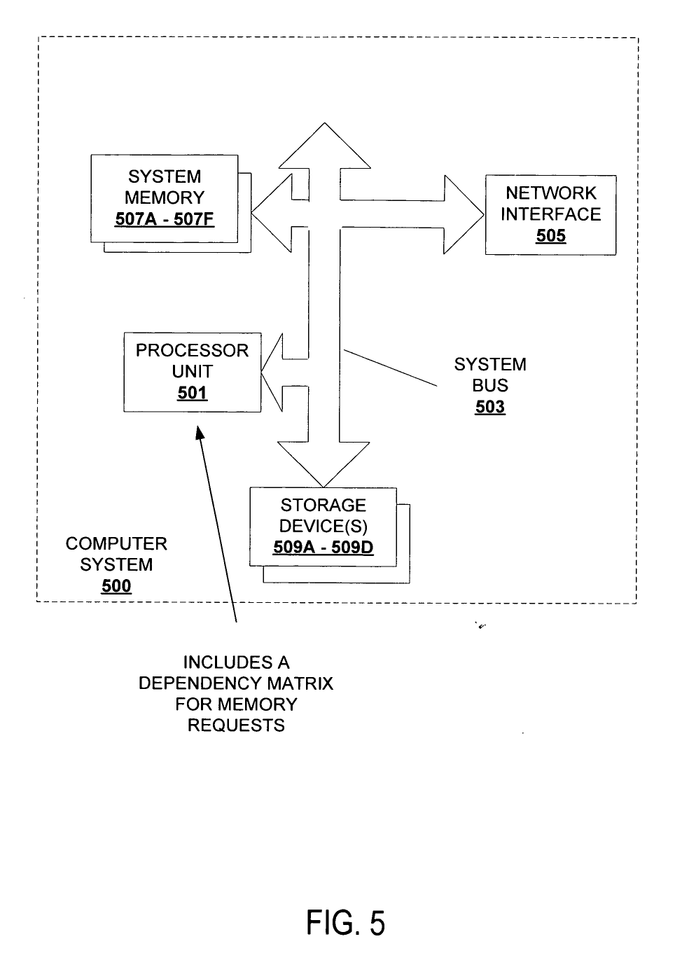

FIG. 5 depicts an exemplary computer system according to various embodiments. A computer system 500 includes a processor unit 501 (possibly including multiple processors). The computer system 500 also includes a main memory 507A - 507F (e.g., one or more of cache, SDRAM, RDRAM, EDO RAM, DDR RAM, EEPROM, etc.), a system bus 503 (e.g., LDT, PCI, ISA, etc.), a network interface 505 (e.g., an ATM interface, an Ethernet interface, a Frame Relay interface, etc.), and a storage device(s) 509A - 509D (e.g., optical storage, magnetic storage, etc.). Embodiments may include fewer or additional components not illustrated in FIG. 5 (e.g., video cards, audio cards, additional network interfaces, peripheral devices, etc.). The processor unit 501, the storage device(s) 509A - 509D, the network interface 505, and the main memory 507A - 507F are coupled to the system bus 503. The processor unit 501 includes a dependency matrix for tracking dependencies of memory requests to be submitted to a memory. Some functionality and/or structure for encoding positional information for tracking dependencies as described herein may be partially or wholly implemented in a memory controller separate from the processor unit 501.

While the invention has been described with reference to various realizations, it will be understood that these realizations are illustrative and that the scope of the invention is not limited to them. Many variations, modifications, additions, and improvements are possible. More generally, realizations in accordance with the present invention have been described in the context of particular realizations. For example, functionality may be separated or combined in blocks differently in various realizations of the invention or described with different terminology.

These realizations are meant to be illustrative and not limiting. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

What is claimed is:

1. A method for scheduling requests to memory comprising:
encoding positional information of memory requests in a memory request buffer to indicate dependencies among the memory requests;
responsive to indication that a first of the memory requests has been serviced, updating the positional information encoding to clear dependencies upon the first memory request; and
selecting at least one of those memory requests that are free of dependencies for scheduling to the memory.

2. The method of claim 1, wherein the positional information is encoded into a two dimensional matrix comprising,
a first dimension of entries that indicates dependencies of memory requests in the memory request buffer; and
a second dimension of entries that indicates dependencies upon memory requests in the memory request buffer.

3. The method of claim 2, wherein clearing dependencies upon the first memory request comprises updating an entry in the second dimension that corresponds to the entry of the memory request buffer that represents the first memory request.

4. The method of claim 3, further comprising:
examining each entry of the first dimension for dependencies responsive to an entry of the second dimension being updated; and
setting a scheduling bit for each of those entries with respective first dimension entries that indicate no dependencies to allow scheduling of the memory requests.

5. The method of claim 2 further comprising setting a scheduling bit for an entry in the memory request buffer if a corresponding entry of the first dimension in the matrix indicates at least one dependency to prevent selection of the memory request for scheduling to the memory.

6. The method of claim 5, wherein the setting the scheduling bit comprises OR'ing together bits of a dependency encoding at the first dimension entry.

7. The method of claim 1, wherein the memory requests comprise at least one of read type requests and write type requests to the memory.

8. The method of claim 1, wherein the memory comprises volatile memory, non-volatile memory, or storage.

9. The method of claim 1 further comprising:
determining dependencies, if any, of an incoming memory request upon memory requests resident in the memory request buffer based, at least in part, on age, type, and target of the memory requests.

10. The method of claim 9, wherein the target of a memory requests comprises an address, an address tag, a cache line, or a compressed address.

11. The method of claim 1 further comprising:
updating a valid bit at an entry in the memory request buffer for the first memory request to indicate that the entry is valid for installation of a new memory request; and
selecting an entry in the memory request buffer for installing an incoming memory request based, at least in part, on the valid bits of the entries.

12. A memory controller comprising:
a memory request buffer operable to host pending requests to a memory;
a compare logic operable to compare an incoming memory request against memory requests resident in the memory request buffer and to encode positional information as a dependency vector to represent dependencies between an incoming memory request and resident memory requests; and
a dependency matrix coupled to receive dependency vectors from the compare logic and coupled to receive indication that a memory request has been serviced, the dependency matrix operable to store the received dependency vectors and to clear dependency representations upon those memory requests that have been serviced.

13. The memory controller of claim 12, wherein the dependency matrix comprises a multi-dimensional array of flip-flops, entries of a first dimension of the matrix indicating dependencies of memory requests at respective entries of the memory request buffer and entries of a second dimension of the matrix indicating dependencies upon memory requests at respective entries of the memory request buffer.

14. The memory controller of claim 13, wherein the dependency matrix is operable to update an entry of the first dimension of the matrix for a memory request responsive to receiving an indication that the memory request has been serviced, and the dependency matrix is operable to update a corresponding entry of the second dimension responsive to the update of the first dimension entry.

15. The memory controller of claim 12 further comprising picker logic coupled with the memory request buffer, the picker logic operable to select memory request from the memory request buffer that are free of dependencies and in accordance with age of the memory requests.

16. The memory controller of claim 15, wherein the picker logic is coupled to receive dependency indications for memory requests in the memory request buffer for selection of memory requests to be submitted to memory.

17. The memory controller of claim 12, wherein the memory request buffer comprises a plurality of entries, each of the plurality of entries being operable to host information about a memory request and an indication of whether the memory request is allowed to be submitted.

18. The memory controller of claim 17, wherein the memory request information at least comprises a memory request type and a memory request target.

19. The memory controller of claim 12, wherein the memory request buffer includes a valid bit for each entry and a scheduling bit for each entry, wherein the valid bit indicates whether the corresponding entry can be overwritten and the scheduling bit indicates whether the memory request at the corresponding entry is free of dependencies.

20. An apparatus comprising:
a memory request buffer;
means for encoding positional information of memory requests in the memory request buffer to represent dependencies; and
means for updating the encoded positional information to clear dependencies upon a serviced memory request responsive to indication of the memory request being serviced.

21. The apparatus of claim 20 further comprising means for selecting memory requests from the memory request buffer for submission to memory, wherein the selecting means are in accordance with age of the memory requests that are free of dependencies.

22. The apparatus of claim 20 further comprising means for receiving indication that a submitted memory request has been serviced.
